(19) United States
(12) Patent Application Publication
(10) Pub. No.: US 2026/0122743 A1
(43) Pub. Date: Apr. 30, 2026

(54) DRIVE CIRCUIT, DRIVE CONTROLLER, AND LAMP

(71) Applicants: SUZHOU OPPLE LIGHTING CO., LTD., Suzhou City (CN); OPPLE LIGHTING CO., LTD., Shanghai (CN); SHENZHEN SUNMOON MICROELECTRONICS CO., LTD., Shenzhen (CN)

(72) Inventors: Feng CHEN, Suzhou City (CN); Zhaohua LI, Suzhou City (CN); Xiaobing SUN, Suzhou City (CN); Jitong FANG, Suzhou City (CN)

(73) Assignees: SUZHOU OPPLE LIGHTING CO., LTD., Suzhou City (CN); OPPLE LIGHTING CO., LTD., Shanghai (CN); SHENZHEN SUNMOON MICROELECTRONICS CO., LTD., Shenzhen (CN)

(21) Appl. No.: 19/433,822

(22) Filed: Dec. 28, 2025

Related U.S. Application Data
(63) Continuation of application No. PCT/CN2024/100279, filed on Jun. 20, 2024.

(30) Foreign Application Priority Data
Jun. 23, 2023 (CN) 202310786893.6
Jun. 23, 2023 (CN) 202321689790.X

(51) Int. Cl. H05B 45/345; H05B 45/14; H05B 45/40; H05B 47/14

(52) U.S. Cl. CPC H05B 45/345; H05B 45/14; H05B 45/40; H05B 47/14

(57) ABSTRACT

Provided in the present disclosure are a drive circuit, a drive controller, and a lamp. The drive circuit includes a load module, an energy storage module, a constant-current control module and a sampling signal module, where the load module includes a first load and a second load, which are connected to a power supply module; the energy storage module is connected to the first load, the power supply module charges the energy storage module, and the energy storage module can supply power to the load module; the constant-current control module includes a first control unit and a fourth control unit, which are connected to the second load in parallel, and a second control unit and a third control unit, which are connected to the second load in series; and the sampling signal module comprises a diode D1 and a sampling module.

### CROSS-REFERENCE TO RELATED DISCLOSURES

This disclosure is based upon and claims the priority of PCT patent disclosure No. PCT/CN2024/100279 filed on Jun. 20, 2024, which claims priority to the Chinese patent disclosure No. 202310786893.6 filed on Jun. 30, 2023 and the Chinese patent disclosure No. 202321689790.X filed on Jun. 30, 2023, the entire contents of which are hereby incorporated by reference herein for all purposes.

### TECHNICAL FIELD

The present disclosure relates to a driving circuit, a driving controller and a lamp, and belongs to the technical field of driving circuit.

### BACKGROUND

With the continuous development of LED lighting industry, the constant current control chip is required to have the characteristics of high integration, good circuit performance and small size.

### SUMMARY

The present disclosure provides a driving circuit and a lamp.

The present disclosure provides a driving circuit, that may be connected to a power supply module, and the driving circuit may include:
a load module includes a first load and a second load that are connected in series, and the first load is connected with the power supply module;
an energy storage module connected to an input terminal of the first load, where the energy storage module may be charged when the power supply module outputs a high voltage, and power may be supplied to the load module by the energy storage module when the power supply module may output a low voltage;
a constant current control module, which may include a first control unit and a fourth control unit that may be connected in parallel with the second load, and a second control unit and a third control unit that may be connected in series with the second load to control the start or stop of the second load; and
a sampling signal module that may include a diode D1 and a sampling module, and the diode D1 may be arranged between the power supply module and the energy storage module, and the sampling module may be connected with an output terminal of the power supply module to sample an output voltage of the power supply module and control the first control unit, the second control unit, the third control unit and the fourth control unit to be turned on or turned off.

The present disclosure also provides a lamp that may include the above-mentioned driving circuit.

It is to be understood that both the foregoing general description and the following detailed description are exemplary and explanatory only and are not restrictive of the present disclosure.

### BRIEF DESCRIPTION OF DRAWINGS

FIG. 1 is a circuit diagram of a constant current drive scheme.

FIG. 2 is a circuit diagram of a driving circuit of an example of the present disclosure.

FIG. 3 is a circuit diagram of a driving controller of an example of the present disclosure.

FIG. 4 is a waveform corresponding to an input voltage after a rectifier bridge and a positive voltage of the energy storage capacitor in the present disclosure.

FIG. 5 is a waveform diagram of an output current after a rectifier bridge, the charging and discharging current of the energy storage capacitor and a current of the LED lamp string in the present disclosure.

FIG. 6 is the corresponding waveforms of an input voltage after a rectifier bridge, a positive voltage of the energy storage capacitor and a current of a first light-emitting unit in the present disclosure.

### DETAILED DESCRIPTION

In order to make the purpose, technical scheme and advantages of the present disclosure more clear, the present disclosure will be described in detail with the attached drawings and examples.

Description of reference numerals used in this disclosure may include:
driving controller 100, driving circuit 200, power supply module 1, chip 2, load module 7, first load 71, second load 72, energy storage module 3, energy storage capacitor C1, diode D2, constant current control module 4, first control module 41, first control unit 411, first controller 412, first transistor M1, second control unit 413, second controller 414, second transistor M2, resistor R3, second control module 42, third control unit 421, third controller 422, third transistor M3, fourth control unit 423, fourth controller 424, fourth transistor M4, resistor R4, sampling signal module 5, diode D1, sampling module 6, comparator 61, converter 62, resistor R1, resistor R2.

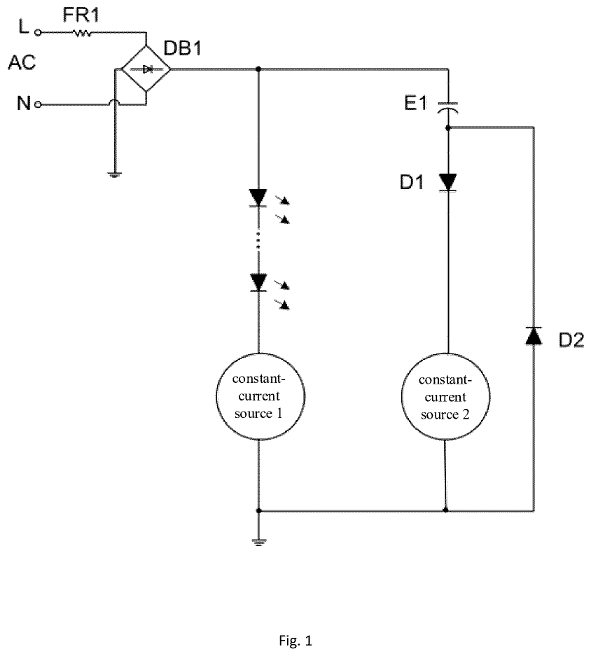

The LED lighting performance index is gradually improving, which makes the certification requirements of linear constant current drive system higher and higher. At present, a linear constant-current drive control system with high power factor has appeared in the market, which is mainly used to realize the constant-current output of LED in commercial AC power above 220V. However, for AC power below 220V or AC power with wide fluctuation range, LED still cannot realize the constant-current output at present, which causes LED to generate perceptible low-frequency ripple strobes under AC power below 220 V, and long-term low-frequency ripple strobes will cause harm to human eyes. As shown in FIG. 1, the scheme of traditional high PF without strobes realizes the constant current output of LED by controlling the charge and discharge of the input capacitor E1. When the fluctuation of commercial power decreases, LED cannot realize the constant current output.

In view of this, it is really necessary to propose a driving circuit, a driving controller and a lamp to solve the above problems.

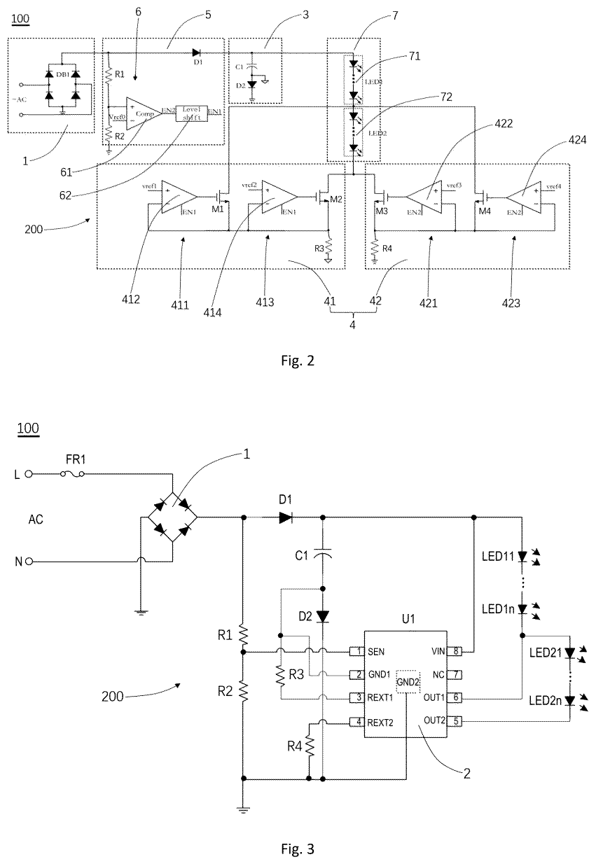

As shown in FIG. 2, the present disclosure discloses a driving circuit 200 which is used to adjust and drive the load, so that the load can work stably when the voltage fluctuates greatly, and at the same time, also has the function of an input high power factor and wide voltage.

The driving circuit 200 is connected with the power supply module 1, supplies power to the driving circuit 200 through the power supply module 1, to ensure the normal operation of the driving circuit 200. The driving circuit 200 includes a load module 7, an energy storage module 3, a constant current control module 4 and a sampling signal module 5. The load module 7 includes a first load 71 and a second load 72 that are connected in series, and the first load 71 is connected with the power supply module 1, so that the power supply module 1 can supply power to the first load 71 and the second load 72, therefore the first load 71 and the second load 72 can work normally; one terminal of the energy storage module 3 is connected with the an input terminal of the first load 71 and an output terminal of the power supply module 1, and the other terminal of the energy storage module 3 is grounded, so that the energy storage module 3 can be charged when the power supply module 1 outputs a high voltage, and when the power supply module 1 outputs a low voltage, the energy storage module 3 can supply power to the load module 7 to prevent the load module 7 from working abnormally when the voltage of the power supply module 1 changes greatly; the constant current control module 4 includes a first control unit 411 and a fourth control unit 423 that are connected in parallel with the second load 72, and a second control unit 413 and a third control unit 421 that are connected in series with the second load 72, to control the start or stop of the second load 72; the sampling signal module 5 includes a diode D1 and a sampling module 6, the diode D1 is arranged between the power supply module 1 and the energy storage module 3, so that the power supply module 1 can supply power to the energy storage module 3 and the load module 7, but the voltage output by the energy storage module 3 cannot flow to the power supply module 1 through the diode D1; the sampling module 6 is connected with the output terminal of the power supply module 1 to sample the output voltage of the power supply module 1 and control the first control unit 411, the second control unit 413, the third control unit 421 and the fourth control unit 421 to be turned on or turned off.

Specifically, the sampling module 6 is connected with the output terminal of the power supply module 1, and the connection point is located between the power supply module 1 and the diode D1, so that the sampling module 6 can directly sample the output voltage of the power supply module 1, and the accuracy of voltage collection by the sampling module 6 is improved.

The energy storage module 3 includes an energy storage capacitor C1, and the constant current control module 4 includes a resistor R3, one terminal of the resistor R3 is connected with the first control unit 411 and the second control unit 413, and the other terminal of the resistor R3 is connected with the energy storage capacitor C1, and the other terminal of the energy storage capacitor C1 is connected with the first load 71 to form a discharge loop circuit. Specifically, when the output voltage of the power supply module 1 drops to a certain value, one of the first control unit 411 and the second control unit 413 is turned on, and the other is turned off, so that the load module 7, the resistor R3 and the energy storage module 3 form a closed loop, realizing that the energy storage capacitor C1 supplies power to the load module 7.

Specifically, the energy storage module 3 includes a diode D2, one terminal of the diode D2 is connected with the energy storage capacitor C1, and the other terminal of the diode D2 is grounded, to form a charging loop circuit of the energy storage capacitor C1. Specifically, by arranging the energy storage module 3 and grounding the energy storage module 3, so that when the driving circuit 200 works, the capacitor can absorb the surge current generated by the external environment, thereby reducing the installation of anti-surge devices in the circuit and reducing the cost of the driving circuit 200; by arranging the diode D2, external currents except the current from the power supply module 1 cannot flow into the capacitor module, so that the positive pole and negative pole of the energy storage module 3 are consistent with those of the power supply module 1, and the positive pole and negative pole of the energy storage module 3 are prevented from changing due to external voltage input.

The constant current control module 4 includes a resistor R4, one terminal of the resistor R4 is connected to the third control unit 421 and the fourth control unit 423, and the other terminal of the resistor R4 is grounded. Specifically, when the voltage output by the power supply module 1 is large, one of the third control unit 421 and the fourth control unit 423 is turned on and the other is turned off, so that the power supply module 1 can supply power to the load module 7, and a loop is formed through the grounded terminal of the resistor R4 to ensure the normal operation of the load module 7.

The sampling module 6 includes a comparator 61 and a converter 62 connected with the comparator 61, the sampling module 6 samples the output voltage of the power supply module 1, inputs the sampling result into the comparator 61, compares the sampling result with a fixed reference of the comparator 61; if the sampling voltage is not less than the fixed reference, the comparator 61 outputs a first control signal to control the third control unit 421 and the fourth control unit 423 to be turned on or turned off; if the sampling voltage is less than the fixed reference of the comparator 61, the comparator 61 controls the converter 62 to output a second control signal to control the first control unit 411 and the second control unit 413 to be turned on or turned off.

That is, when the voltage of the power supply module 1 is high, one of the third control unit 421 and the fourth control unit 423 is turned on and the other is turned off, so that the power supply module 1 supplies power to the load module 7 and charges the energy storage module 3 at the same time; when the voltage of the power supply module 1 is low, one of the first control unit 411 and the second control unit 413 is turned on and the other is turned off, so that the energy storage module 3 supplies power to the load module 7, and the output power of the load module 7 is prevented from being reduced due to the voltage drop.

Specifically, the constant current control module 4 is provided with a first control module 41 including the first control unit 411 and the second control unit 413, and a second control module 42 including the third control unit 421 and the fourth control unit 423. When one of the first control unit 411 and the second control unit 413 in the first control module 41 is turned on, both the third control unit 421 and the fourth control unit 423 in the second control module 42 are turned off, so that during the same time, only one selected from the group consisting of the first control unit 411, the second control unit 413, the third control unit 421 and the fourth control unit 423 is turned on, and the other three selected from the group are turned off, so as to realize the normal operation of the first load 71 and accurately control the start or stop of the second load 72.

In other words, the comparator 61 preliminarily judges the sampling voltage. If the sampling voltage is higher than the nominal voltage of the first load 71, the comparator 61 sends out a first control signal to control the operation of the first control module 41, and if the sampling voltage is lower than the nominal voltage of the first load 71, the comparator 61 sends out a second control signal to control the operation of the second control module 42.

In this example, the load module 7 includes the first load 71 and the second load 72, and the constant current control module 4 includes the first control module 41 and the second control module 42. Of course, in other examples, there may be a plurality of load modules 7 and a plurality of constant current control modules 4, as long as the first load 71 can be kept in normal operation and the second load 72 and more loads can operates at high voltages, there is no limitation to this here.

The third control unit 421 includes a third controller 422 and a third transistor M3, one terminal of the third transistor M3 is connected to the third controller 422, another terminal of the third transistor M3 is connected to the output terminal of the second load 72, and still another terminal of the third transistor M3 is grounded. The third controller 422 receives the first control signal and compares the first control signal with a third reference of the third controller 422. If the first control signal is equal to the third reference, the third controller 422 controls the third transistor M3 to be turned on.

The fourth control unit 423 includes a fourth controller 424 and a fourth transistor M4, one terminal of the fourth transistor M4 is connected to the fourth controller 424, another terminal of the fourth transistor M4 is connected to the input terminal of the second load 72, and still another terminal of the fourth transistor M4 is grounded. The fourth controller 424 receives the first control signal and compares the first control signal with a fourth reference of the fourth controller 424. If the first control signal is equal to the fourth reference, the fourth controller 424 controls the fourth transistor M4 to be turned on.

Specifically, the grounded terminals of the third transistor M3 and the fourth transistor M4 are connected, and both of the two are grounded through the resistor R4. The comparator 61 outputs the first control signal according to the voltage ranges of the sampling voltage, so that the first control signal includes two different values according to the different voltage ranges of the sampling voltage, the two values correspond to the third reference and the fourth reference respectively, and the value of the third reference is greater than the value of the fourth reference. When the third transistor M3 is turned on, it shows that the output voltage of the power supply module 1 is large, and the first load 71 and the second load 72 are connected in series to share the voltage, so as to avoid the damage of the first load 71 caused by excessive voltage. When the third transistor M3 is turned off and the fourth transistor M4 is turned on, it means that the output voltage of the power supply module 1 is normal and can satisfy the normal operation of the first load 71, that is, the second load 72 does not operate at this time.

In this example, the comparator 61 outputs first control signals with different values to control the turn-on and turn-off of the third transistor M3 and the fourth transistor M4, and the value of the third reference is greater than that of the fourth reference. Of course, in other examples, the value of the third reference may be smaller than that of the fourth reference, and the comparator 61 may also make a preliminary judgment on the sampling voltage and then send the sampling voltage to the third controller 422 and the fourth controller 424. The sampling voltage is judged by the third controller 422 and the fourth controller 424, and then the third transistor M3 and the fourth transistor M4 are controlled to be turned on or turned off, which is not limited here.

The second control unit 413 includes a second controller 414 and a second transistor M2, one terminal of the second transistor M2 is connected to the second controller 414, another terminal of the second transistor M2 is connected to the output terminal of the second load 72, and still another terminal of the second transistor M2 is connected to the energy storage module 3. The second controller 414 receives the second control signal and compares the second control signal with a second reference of the second controller 414. If the second control signal is equal to the second reference, the second controller 414 controls the second transistor M2 to be turned on.

The first control unit 411 includes a first controller 412 and a first transistor M1, one terminal of the first transistor M1 is connected to the first controller 412, another terminal of the first transistor M1 is connected to the input terminal of the second load 72, and still another terminal of the first transistor M1 is connected to the energy storage module 3. The first controller 412 receives the second control signal and compares the second control signal with a first reference of the first controller 412. If the second control signal is equal to the first reference, the first controller 412 controls the first transistor M1 to be turned on.

Specifically, the grounded terminals of the first transistor M1 and the second transistor M2 are connected, and both of the two are grounded through the resistor R3. The comparator 61 controls the converter 62 to output a second control signal according to the range of the sampling voltage, so that the second control signal includes two different values according to different ranges of the sampling voltage, the two values correspond to the first reference and the second reference respectively, and the value of the second reference is greater than that of the first reference. When the second transistor M2 is turned on, it means that the voltage across the load module 7 is relatively large, and the first load 71 and the second load 72 are connected in series to share the voltage, so as to avoid the damage of the first load 71 caused by excessive voltage. When the second transistor M2 is turned off and the first transistor M1 is turned on, it means that the voltage across the load module 7 is normal and can satisfy the normal operation of the first load 71, that is, the second load 72 does not operate at this time.

Specifically, the sampling module 6 further comprises a resistor R1 and a resistor R2, the resistor R1 is arranged between the comparator 61 and the power supply module 1, and one terminal of the resistor R2 is connected with the input terminal of the comparator 61, and the other terminal of the resistor R2 is grounded, so that the sampling module 6 forms a sampling loop circuit to sample the voltage of the power supply module 1.

As shown in FIG. 3, the present disclosure also provides a drive controller 100, which includes a power supply module 1 and a drive circuit 200. The power supply module 1 converts an alternating current of a power grid into a direct current to supply power to the drive circuit 200, and part of the drive circuit 200 is arranged in a chip 2, and an isolation device is arranged in the chip 2 to separate the first control module 41 and the second control module 42, so that a discharge loop circuit is formed between the first control module 41 and the energy storage module 3.

Specifically, the power supply module 1 is composed of a rectifier bridge or four diodes, which is connected to the network voltage alternating current, and electrically converts the current into a direct current and then inputs the direct current into the driving circuit 200.

Specifically, the input terminal of resistor R3 is connected with the output terminal of power supply module 1, the output terminal of resistor R3 is connected with a pin 1 of the chip 2 and the input terminal of resistor R4 respectively, and the output terminal of resistor R4 is grounded. That is to say, the comparator 61 and the converter 62 are arranged in the chip 2 and connected with the resistor R3 and the resistor R4 through the pin 1 to sample the output voltage of power supply module 1. Further, the comparator 61 and the converter 62 complete the comparison of the sampled voltage and send the first control signal or the second control signal to the constant current control module 4 in the chip 2.

The input terminal of diode D1 is connected with the output terminal of power supply module 1, and the output terminal of diode D1 is connected with storage capacitor C1, a pin 8 of the chip 2 and the input terminal of the first load 71 respectively, so that the power supply module 1 can supply power to the storage capacitor C1 and the first load 71.

The output terminal of the energy storage capacitor C1 is connected with the diode D2 and then grounded, so that the energy storage capacitor C1 and the power supply module 1 can form a charging loop circuit. The output terminal of the energy storage capacitor C1 is connected with a pin 2 of the chip 2, and the output terminal of the energy storage capacitor C1 is also connected with the resistor R3, and the other terminal of the resistor R3 is connected with a pin 3 of the chip 2.

The output terminal of the first load 71 is connected to a pin 6 of the chip 2 and the input terminal of the second load 72, and the output terminal of the second load 72 is connected to a pin 5 of the chip 2. That is to say, the constant current control module 4 is integrated in the chip 2, which reduces the number of components in the drive controller 100 and further improves the integration of the drive control circuit.

The connection mode and control mode of the sampling module 6 and the constant current control module 4 in the chip 2 are as described above, which will not be described in detail here. It should be noted that there is an isolation device in the chip 2 to separate the first control module 41 and the second control module 42, so that there is no current interaction between the first control module 41 and the second control module 42, and the first control module 41 and the energy storage module 3 communicate with each other to form a discharge loop circuit of the energy storage module 3.

A Pin 4 of the chip 2 is connected with the resistor R4, the output terminal of the resistor R4 is grounded, and the chip 2 is grounded to prevent the chip 2 from being damaged due to static electricity.

The present disclosure also provides a lamp, which comprises the aforementioned drive controller 100, a shell, a base and a mask, etc., the structures and connection relationship of the base, the shell and the mask can be set according to other implementations, and will not be described in detail here. The first load 71 and the second load 72 are respectively the first light emitting unit and the second light emitting unit of the lamp, and the lamp may be the LED lamp specifically. By arranging the drive circuit 200, the LED lamp has no stroboscopic phenomenon, and the protection of human eyes is improved. At the same time, by arranging the constant current control module 4 and the energy storage module 3, the LED lamp has high power factor and wide voltage input function, and the practicability of the LED lamp is improved.

In order to facilitate the understanding of the technical scheme of the present disclosure, the following contents will specifically explain the cooperation relationship among the sampling signal module 5, the energy storage module 3, the load module 7 and the constant current control module 4.

The first light emitting unit and the second light emitting unit are connected in series to form an LED lamp string, the diode D2 and the energy storage capacitor C1 form a charging circuit, and the energy storage capacitor C1, the LED lamp string and the constant current control module 4 form a discharging circuit. The diode D1 is arranged between the sampling signal module 5 and the energy storage module 3 to isolate the energy storage capacitor C1 and sample the voltage after the rectifier bridge. The diode D2 is used to provide a charging loop circuit for the storage capacitor C1 and isolate the current of the second control module 42.

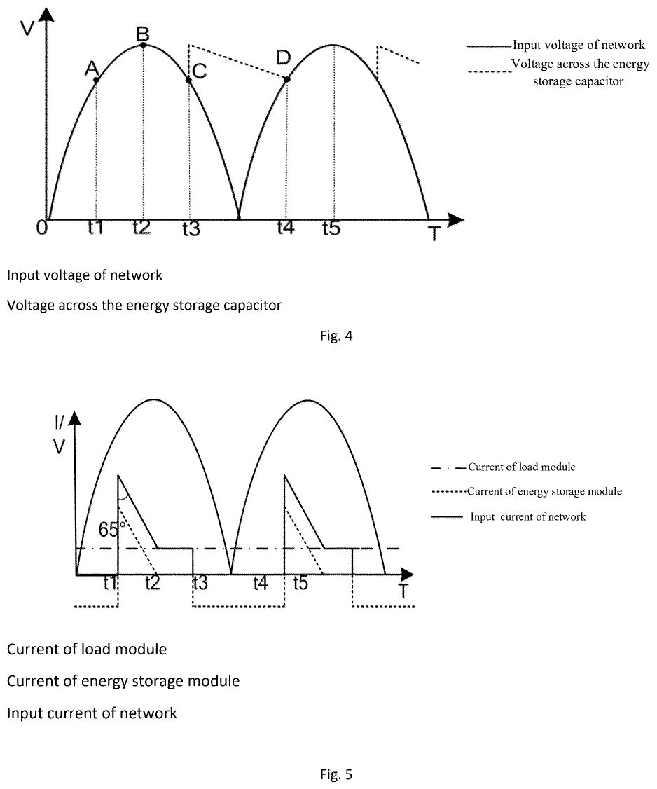

Please refer to FIG. 4. The rectified network voltage charges the energy storage capacitor C1, and the initial charging process of the energy storage capacitor C1 is from point 0 to point B, and this process is not controlled by IC, and the charging is completed quickly.

Please refer to FIG. 5, in a grid period, the phase angle of the input current of the grid alternating current from no current to peak current is less than 65°, and the phase angle when the input current of the grid alternating current drops to 5% of the peak value of the input current is greater than or equal to 90°.

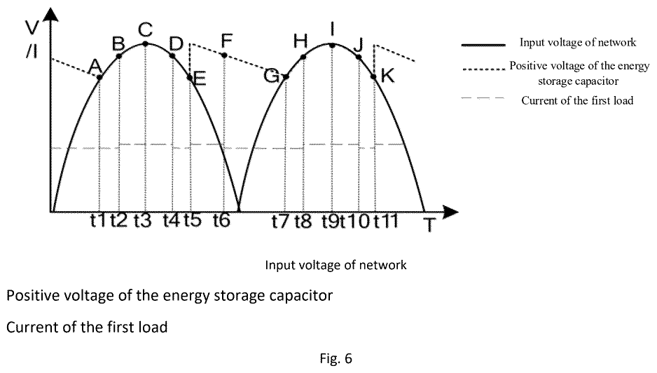

Please refer to FIG. 2 and FIG. 6, in the case of 220Vac operation, it is assumed that the voltage of the first light-emitting unit is 200V, the voltage of the second light-emitting unit is 50V, and the minimum starting voltages of the first transistor M1, the second transistor M2, the third transistor M3 and the fourth transistor M4 are all set to 10V, and the feedback voltage point is assumed to be 210V, the fourth reference vref4-0.6V, the third reference vref3-0.7V, the first reference vref1=0.6V, and the second reference vref2=0.7v. In other examples, the above data can be designed according to the actual situation, and there is no restriction here.

When the grid voltage is higher than 210V, that is, point A in the figure, the third transistor M3 is turned off and the fourth transistor M4 is turned on, so that the first light-emitting unit works normally. When the grid voltage is higher than 260V, that is, point B in the figure, the third transistor M3 is turned on and the fourth transistor M4 is turned off, so that both the first light-emitting unit and the second light-emitting unit work normally. The third reference is greater than the fourth reference, so that when the third transistor M3 is turned on, the fourth transistor M4 is turned off.

When the grid voltage drops to 260V, that is, point D in the figure, the third transistor M3 is turned off and the fourth transistor M4 starts to be turned on, at this time, the first light-emitting unit is turned on and the second light-emitting unit is turned off. When the grid voltage drops to 210V, that is, point E in the figure, the first control signal turns off the third transistor M3 and the fourth transistor M4, and the second control signal turns on the first transistor M1 and the second transistor M2, and the energy storage capacitor C1 supplies power to the first light-emitting unit and the second light-emitting unit, at this time, the voltage across the energy storage capacitor C1 is about 310V, the second transistor M2 is turned on, and the first transistor M1 is turned off, so that both the first light-emitting unit and the second light-emitting unit work normally. When the voltage across the storage capacitor C1 drops to 260V, that is, point F in the figure, the second transistor M2 is turned off, the first transistor M1 is turned on, the first light-emitting unit is turned on, and the storage capacitor C1 continues to discharge to 210V, that is, point G in the figure, at this time, the network voltage also rises to 210 V. Then, the above steps are repeated to realize that the first light-emitting unit is always on, reducing the stroboscopic effect of the lamp and improving the protection of the lamp to human eyes.

Period G-I is a process of charging the energy storage capacitor C1 by the grid voltage, period E-G is a discharge process of the energy storage capacitor C1 to the LED lamp string, and period C-E is a process of maintaining the voltage at both terminals of the energy storage capacitor C1 unchanged.

Period t1-t2 and period t4-t5 are the time when the grid voltage supplies power to the first light-emitting unit and the first transistor M1, and period t2-t3-t4 are the time when the grid voltage supplies power to the first light-emitting unit, the second light-emitting unit and the third transistor M3. Period t5-t6 are the time when the energy storage capacitor C1 supplies power to the first light-emitting unit, the second light-emitting unit and the second transistor M2, and period t6-t7 are the time when the energy storage capacitor C1 supplies power to the first light-emitting unit and the first transistor M1.

The sampling signal module 5 samples the output voltage of the power supply module 1 and inputs the sampling result into the internal comparator 61. The comparator 61 outputs the first control signal EN2 to control the turn-on and turn-off of the third transistor M3 and the fourth transistor M4. Meanwhile, the output port of the comparator 61 can also output a second control signal EN1 through the converter to control the turn-on and turn-off of the first transistor M1 and the second transistor M2. When the input voltage is higher than the voltage at point A, the third transistor M3 and the fourth transistor M4 are turned on, and the first transistor M1 and the second transistor M2 are turned off at the same time; when the input voltage is lower than the voltage at point E, the first transistor M1 and the second transistor M2 are turned on, and the third transistor M3 and the fourth transistor M4 are turned off at the same time. By controlling the turn-on and turn-off of the first transistor M1, the second transistor M2, the third transistor M3 and the fourth transistor M4, the constant current output of the LED lamp string is realized in the entire network period.

When the input voltage of network is greater than the voltage across the two terminals of the storage capacitor C1, that is, at the stage from point A to point B, the current charges the storage capacitor C1 through the storage capacitor C1, the diode D1 and the diode D2, and the charging of the storage capacitor C1 is not controlled by the chip 2.

When the rectified network voltage is less than or equal to the voltage across the energy storage capacitor C1, the input current stops charging the energy storage capacitor C1; when the network voltage is lower than the voltage at point E, the energy storage capacitor C1 discharges the LED lamp string loop to maintain the current of the LED lamp string.

To sum up, the driving circuit 200 of the present disclosure is provided with the energy storage module 3 and the constant-current control module 4, so that the load module 7 can realize constant current output when the voltage fluctuates greatly, and also has the characteristics of high power factor, wide voltage, no strobes and strong surge resistance, further avoiding the stroboscopic phenomenon of the LED light string when the voltage fluctuates, and further improving the protection of human eyes.

The purpose of the present disclosure is to provide a driving circuit, a driving controller and a lamp, so as to solve the problem that in other implementations, an LED cannot realize constant current output when the fluctuation of commercial power decreases.

In order to achieve the above object, the present disclosure provides a driving circuit, connected to a power supply module, comprising:
a load module comprises a first load and a second load that are connected in series, and the first load is connected with the power supply module;
an energy storage module connected to an input terminal of the first load, wherein the energy storage module is charged when the power supply module outputs a high voltage, and power is supplied to the load module by the energy storage module when the power supply module outputs a low voltage;
a constant current control module, comprising a first control unit and a fourth control unit that are connected in parallel with the second load, and a second control unit and a third control unit that are connected in series with the second load to control the start or stop of the second load; and
a sampling signal module, comprising a diode D1 and a sampling module, wherein the diode D1 is arranged between the power supply module and the energy storage module, and the sampling module is connected with an output terminal of the power supply module to sample an output voltage of the power supply module and control the first control unit, the second control unit, the third control unit and the fourth control unit to be turned on or turned off.

Optionally, the energy storage module comprises an energy storage capacitor C1, and the constant current control module comprises a resistor R3, one terminal of the resistor R3 is connected with the first control unit and the second control unit, and the other terminal of the resistor R3 is connected with the energy storage capacitor C1, and other terminal of the energy storage capacitor C1 is connected with the first load, to form a discharging loop circuit.

Optionally, the energy storage module comprises a diode D2, one terminal of the diode D2 is connected with the energy storage capacitor C1, and the other terminal of the diode D2 is grounded, to form a charging loop circuit of the energy storage capacitor C1.

Optionally, the constant current control module comprises a resistor R4, one terminal of the resistor R4 is connected with the third control unit and the fourth control unit, and the other terminal of the resistor R4 is grounded.

Optionally, the sampling module comprises a comparator, the sampling module samples the voltage of the power supply module, inputs a sampling result into the comparator, and compares the sampling result with a fixed reference of the comparator; if the sampling voltage is not less than the fixed reference, the comparator outputs a first control signal to control the third control unit and the fourth control unit to be turned on or turned off.

Optionally, the third control unit comprises a third controller and a third transistor M3, one terminal of the third transistor M3 is connected to the third controller, another terminal of the third transistor M3 is connected to an output terminal of the second load, and still another terminal of the third transistor M3 is grounded; the third controller receives the first control signal, and compares the first control signal with a third reference of the third controller; if the first control signal is equal to the third reference, the third controller controls the third transistor M3 to be turned on;

the fourth control unit comprises a fourth controller and a fourth transistor M4, one terminal of the fourth transistor M4 is connected with the fourth controller, another terminal of the fourth transistor M4 is connected with an input terminal of the second load, and still another terminal of the fourth transistor M4 is grounded; the fourth controller receives the first control signal, and compares the first control signal with a fourth reference of the fourth controller; if the first control signal is equal to the fourth reference, the fourth controller controls the fourth transistor M4 to be turned on.

Optionally, the sampling module further comprises a converter connected with the comparator, and if a sampling voltage is less than the fixed reference, the comparator controls the converter to output a second control signal to control the first control unit and the second control unit to be turned on or turned off.

Optionally, the second control unit comprises a second controller and a second transistor M2, one terminal of the second transistor M2 is connected to the second controller, another terminal of the second transistor M2 is connected to an output terminal of the second load, and still another terminal of the second transistor M2 is connected to the energy storage module; the second controller receive the second control signal and compares the second control signal with a second reference of the second controller; if the second control signal is equal to the second reference, the second controller controls the second transistor M2 to be turned on;

the first control unit comprises a first controller and a first transistor M1, one terminal of the first transistor M1 is connected with the first controller, another terminal of the first transistor M1 is connected with an input terminal of the second load, and still another terminal of the first transistor M1 is connected with the energy storage module; the first controller receives the second control signal and compares the second control signal with a first reference of the first controller; if the second control signal is equal to the first reference, the first controller controls the first transistor M1 to be turned on.

In order to achieve the above object, the present disclosure provides a drive controller, comprising a power supply module and the above-mentioned drive circuit, the power supply module converts an alternating current of a power grid into a direct current to supply power to the drive circuit, and part of the drive circuit is arranged in a chip, the constant current control module is provided with a first control module comprising the first control unit and the second control unit, and a second control module comprising a third control unit and a fourth control unit; an isolation device is arranged in the chip, the isolation device separates the first control module and the second control module, so that a discharge loop circuit is formed between the first control module and the energy storage module.

In order to achieve the above object, the present disclosure provides a lamp comprising the above-mentioned driving circuit.

The advantages of the driving circuit are as follows: the energy storage module and the constant current control module are arranged in the driving circuit provided by the present disclosure, so that the load can realize constant current output when the voltage fluctuates greatly, and the driving circuit also has the characteristics of high power factor, wide voltage, no strobes and strong surge resistance, further avoiding the stroboscopic phenomenon of the lamp beads when the voltage fluctuates, and further improving the protection of human eyes.

The present disclosure may include dedicated hardware implementations such as disclosure specific integrated circuits, programmable logic arrays and other hardware devices. The hardware implementations can be constructed to implement one or more of the methods described herein. Examples that may include the apparatus and systems of various implementations can broadly include a variety of electronic and computing systems. One or more examples described herein may implement functions using two or more specific interconnected hardware modules or devices with related control and data signals that can be communicated between and through the modules, or as portions of an disclosure-specific integrated circuit. Accordingly, the system disclosed may encompass software, firmware, and hardware implementations. The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. The module refers herein may include one or more circuit with or without stored code or instructions. The module or circuit may include one or more components that are connected.

The above examples are only used to illustrate the technical scheme of the present disclosure, but not to limit it. Although the present disclosure has been described in detail with reference to examples, it should be understood by those skilled in the art that the technical scheme of the present disclosure can be modified or replaced by equivalents without departing from the spirit and scope of the technical scheme of the present disclosure.

1. A driving circuit, configured to be connected to a power supply module, comprising:
a load module comprising a first load and a second load that are connected in series, wherein the first load is connected with the power supply module;
an energy storage module connected to an input terminal of the first load, wherein the energy storage module is configured to be charged when the power supply module outputs a high voltage, and to supply power to the load module when the power supply module outputs a low voltage;
a constant current control module, comprising a first control unit and a fourth control unit that are connected in parallel with the second load, and a second control unit and a third control unit that are connected in series with the second load, to control the start or stop of the second load; and
a sampling signal module, comprising a diode D1 and a sampling module, wherein the diode D1 is arranged between the power supply module and the energy storage module, and the sampling module is connected with an output terminal of the power supply module to sample an output voltage of the power supply module and control the first control unit, the second control unit, the third control unit and the fourth control unit to be turned on or turned off.

2. The driving circuit according to claim 1, wherein the energy storage module comprises an energy storage capacitor C1, and the constant current control module comprises a resistor R3, one terminal of the resistor R3 is connected with the first control unit and the second control unit, and other terminal of the resistor R3 is connected with the energy storage capacitor C1, and other terminal of the energy storage capacitor C1 is connected with the first load, such that a discharging loop circuit is formed.

3. The driving circuit according to claim 2, wherein the energy storage module comprises a diode D2, one terminal of the diode D2 is connected with the energy storage capacitor C1, and other terminal of the diode D2 is grounded, such that a charging loop circuit of the energy storage capacitor C1 is formed.

4. The driving circuit according to claim 1, wherein the constant current control module comprises a resistor R4, one terminal of the resistor R4 is connected with the third control unit and the fourth control unit, and other terminal of the resistor R4 is grounded.

5. The driving circuit according to claim 1, wherein the sampling module comprises a comparator, the sampling module samples the voltage of the power supply module, inputs a sampling result into the comparator, and compares the sampling result with a fixed reference of the comparator; and when the sampling voltage is not less than the fixed reference, the comparator outputs a first control signal to control the third control unit and the fourth control unit to be turned on or turned off.

6. The driving circuit according to claim 5, wherein the third control unit comprises a third controller and a third transistor M3, one terminal of the third transistor M3 is connected to the third controller, another terminal of the third transistor M3 is connected to an output terminal of the second load, and still another terminal of the third transistor M3 is grounded; the third controller receives the first control signal, and compares the first control signal with a third reference of the third controller; when the first control signal is equal to the third reference, the third controller controls the third transistor M3 to be turned on; and
the fourth control unit comprises a fourth controller and a fourth transistor M4, one terminal of the fourth transistor M4 is connected with the fourth controller, another terminal of the fourth transistor M4 is connected with an input terminal of the second load, and still another terminal of the fourth transistor M4 is grounded; the fourth controller receives the first control signal, and compares the first control signal with a fourth reference of the fourth controller; when the first control signal is equal to the fourth reference, the fourth controller controls the fourth transistor M4 to be turned on.

7. The driving circuit according to claim 5, wherein the sampling module further comprises a converter connected with the comparator, and when a sampling voltage is less than the fixed reference, the comparator controls the converter to output a second control signal to control the first control unit and the second control unit to be turned on or turned off.

8. The driving circuit according to claim 7, wherein the second control unit comprises a second controller and a second transistor M2, one terminal of the second transistor M2 is connected to the second controller, another terminal of the second transistor M2 is connected to an output terminal of the second load, and still another terminal of the second transistor M2 is connected to the energy storage module; the second controller receive the second control signal and compares the second control signal with a second reference of the second controller; when the second control signal is equal to the second reference, the second controller controls the second transistor M2 to be turned on; and
the first control unit comprises a first controller and a first transistor M1, one terminal of the first transistor M1 is connected with the first controller, another terminal of the first transistor M1 is connected with an input terminal of the second load, and still another terminal of the first transistor M1 is connected with the energy storage module; the first controller receives the second control signal and compares the second control signal with a first reference of the first controller; when the second control signal is equal to the first reference, the first controller controls the first transistor M1 to be turned on.

9. A drive controller, comprising a power supply module and the drive circuit according to claim 1, wherein the power supply module converts an alternating current of a power grid into a direct current to supply power to the drive circuit, and part of the drive circuit is arranged in a chip, the constant current control module is provided with a first control module comprising the first control unit and the second control unit, and a second control module comprising a third control unit and a fourth control unit; an isolation device is arranged in the chip, the isolation device separates the first control module and the second control module, such that a discharge loop circuit is formed between the first control module and the energy storage module.

10. A lamp, comprising a driving circuit wherein the driving circuit is configured to be connected to a power supply module, and the driving circuit comprises:
a load module comprising a first load and a second load that are connected in series, wherein the first load is connected with the power supply module;
an energy storage module connected to an input terminal of the first load, wherein the energy storage module is configured to be charged when the power supply module outputs a high voltage, and to supply power to the load module when the power supply module outputs a low voltage;
a constant current control module, comprising a first control unit and a fourth control unit that are connected in parallel with the second load, and a second control unit and a third control unit that are connected in series with the second load, to control the start or stop of the second load; and
a sampling signal module, comprising a diode D1 and a sampling module, wherein the diode D1 is arranged between the power supply module and the energy storage module, and the sampling module is connected with an output terminal of the power supply module to sample an output voltage of the power supply module and control the first control unit, the second control unit, the third control unit and the fourth control unit to be turned on or turned off.
